(19) United States
(12) Patent Application Publication
(10) Pub. No.: US 2019/0266596 A1
(43) Pub. Date: Aug. 29, 2019

(54) INTEGRATED INSURANCE AND PAYMENTS ACCOUNT

(71) Applicant: LEVEL BENEFITS, INC., New York, NY (US)

(72) Inventors: Paul AARON, New York, NY (US); Etan ZAPINSKY, New York, NY (US)

(21) Appl. No.: 16/285,960

(22) Filed: Feb. 26, 2019

Related U.S. Application Data
(60) Provisional application No. 62/635,281, filed on Feb. 26, 2018.

(51) Int. Cl. G06Q 20/34; G06Q 10/10; G06Q 20/36

(52) U.S. Cl. CPC G06Q 20/3572; G06Q 20/3674; G06Q 10/10

(57) ABSTRACT

This invention is an insurance product that works for individual users like a credit-based payment card. Users pay with their account, which is processed via traditional systems including swiping a card via payment terminal, card payment networks, and acquiring banks, to utilize their insurance benefits. The insurance company incorporates data from the payment card transaction along with information supplied by the provider (eg Dentists) via the insurance website, Electronic Data Interchange (EDI) systems, as well as directly from the user's web and mobile apps, to adjudicate claims. In this model, claims are processed to determine the procedure and corresponding benefit price according to the user's insurance plan. The invention also enables providers to lookup users to check benefits and submit claims for reimbursement against those users. The provider is paid through their merchant acquirer as they would for any credit card transaction. This invention connects multiple accounts, including payment balances and insurance plans, together under a single account that can be accessed via a physical payment card, digital wallet, online profile, or identifying token.

### RELATED APPLICATIONS

This application claims the benefit of U.S. Provisional Application Ser. No. 62/635,281 filed Feb. 26, 2018 entitled “Integrated Insurance and Payments Account,” which is hereby incorporated by reference in its entirety.

### FIELD OF INVENTION

This invention relates to people who use medical and supplemental insurance, credit and debit cards, and have to pay bills that may or may not be covered by insurance or other benefits.

### BACKGROUND INFORMATION

Today when an individual goes to a provider (eg doctor or dentist), she/he must frequently present multiple cards at checkout (insurance card to check the rates to charge you and start the claims processing process, and your credit card or cash to pay your copay). This requires individuals to carry around multiple cards and share more sensitive information.

### SUMMARY OF YOUR INVENTION

This invention solves this problem by combining multiple accounts including payment balances and insurance plans, together under a single account that can be accessed via a physical payment card, digital wallet, online profile, or identifying token.

The customer or billing department at provider's office can lookup the customer's benefits using the single account, either by using the insurance company's web portal or calling the insurance company, so that the customer knows how much of the visit will be covered.

A customer with this invention arrives at a provider's office for service. After the service the customer proceeds to pay for the visit with the provider's billing department. The billing department charges the customer for the cost of the visit over the payment card network (eg. by using the physical payment card) and submits claim information on the insurance company website or via Electronic Data Interchange (EDI) systems.

After this payment is processed by the payment card network, the transaction is sent to the insurance system via the issuing processor. Before approving the transaction, the system checks the customer's insurance account benefits, which are pre-defined as per the customer's insurance plan's schedule of benefits, to determine if the transaction should be approved, and for how much. Depending on the schedule of benefits and remaining benefits left in the term, the system returns an approved/denied response to the provider's payments terminal.

If approved, the insurance company remits the amount of funds approved to the provider over the payment card network. If denied, the insurance company remits no funds to the provider.

After the payment transaction completes the provider can proceed to finish their transaction with the customer having interacted with the insurance and payments processing in a single interaction.

If there was an issue after the user leaves the providers office, the provider can submit a claim to the insurance system, identifying the customer by their single account. Similar to the claim submitted while the user is with the provider, the submitted claim is compared to users schedule of benefits and use, and is then remitted over the payments network or by other means.

### DRAWINGS

FIG. 1. Single account backed by multiple payment and insurance accounts,

FIG. 2. Flow diagram of payments+insurance network

### DETAILED DESCRIPTION OF YOUR INVENTION

The invention involves the following systems and components:
(A) One payment account that can authenticate and represent multiple accounts, including insurance and credit balances.
(B) System that debit and credits insurance and payment balances.
(C) Ledger that keeps track of all transactions, claims, adjustments, and user actions.
(D) System for processing insurance claims that incorporates data from multiple sources, including provider data, payment card, and user generated. This includes data from Electronic Data Interchange (EDI) via patient management systems.
(E) System for processing claims in which reimbursement amounts are paid per service, reason for visit, or other arrangement.
(F) System for paying claims and exchanging reports via existing card payments networks.
(G) Support for multiple credentials for account authentication and authorization including, payment card, token number, and online profile.
(H) System where a provider or other user can look-up insurance benefits via account credentials, including token or account number.

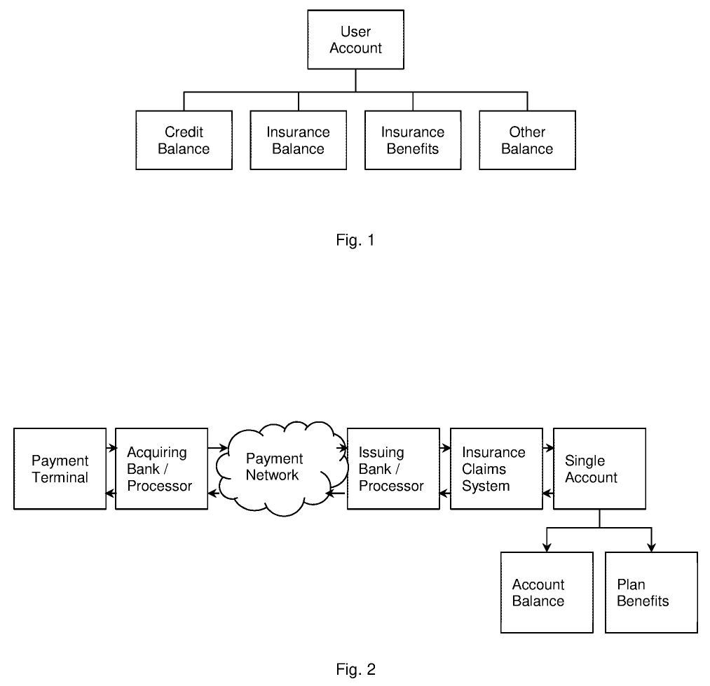

The main user account from Component (A) contains the systems that debit and credit insurance and payments balances (B) and records all the transactions on the ledger (C). See FIG. 1 for how these components interact.

When processing a payment that's potentially covered by the insurance benefits the payment flows through Component (D), (E), (F), (G) as described in FIG. 2.

### Examples Of How It Will Be Used

This invention will be used by people when they:
Go to the dentist and want to use Dental Insurance.
Go to the optometrist and want to use Vision Insurance.
Go to the doctor and want to use Medical Insurance.
Go to the auto-repair shop and want to use Car Insurance.
Go to the veterinarian and want to use Pet Insurance.

The product may be purchased by individuals directly or dispensed to employees by employers as a benefit (eg, dental insurance).

1. A single account which comprises of multiple sub-accounts, including insurance and credit balances.

2. A single account which comprises of two or more sub-accounts, an insurance account and a payments account which can be identified by the same account number.

3. A system wherein a transaction can debit or credit one or multiple accounts for one or multiple users across various balance types, including credit, secured credit, and insurance.

4. A system consisting of a ledger for user actions, transactions, claims, reimbursements, adjustments for one or multiple accounts across various types of balance, including credit, secured credit, and insurance.

5. A system to adjudicate and process insurance claims wherein data from card payment transactions (eg, Merchant ID, payment amount) is combined with other data including from provider claim submissions via online web app or EDI service.

6. A system wherein user generated data, phone location, is combined with payment card transaction data to initiate claims processing for an insurance plan.

7. A system wherein an insurance claim is reimbursed via payment card network enabling transaction clearing via acquiring bank and card network.

8. A system for reporting wherein card payment transactions can be connected to claims reimbursements.
